(19) United States
(12) Patent Application Publication
(10) Pub. No.: US 2022/0375453 A1
(43) Pub. Date: Nov. 24, 2022

(54) METHOD AND APPARATUS FOR SPEECH SYNTHESIS, AND STORAGE MEDIUM

(71) Applicant: BEIJING BAIDU NETCOM SCIENCE TECHNOLOGY CO., LTD., Beijing (CN)

(72) Inventors: Junteng Zhang, Beijing (CN); Jianmin Wu, Beijing (CN); Tao Sun, Beijing (CN); Lei Jia, Beijing (CN)

(73) Assignee: BEIJING BAIDU NETCOM SCIENCE TECHNOLOGY CO., LTD., Beijing (CN)

(21) Appl. No.: 17/875,529

(22) Filed: Jul. 28, 2022

(30) Foreign Application Priority Data
Aug. 17, 2021 (CN) 202110944989.1

(51) Int. Cl. G10L 13/10; G10L 13/06; G10L 13/047; G10L 25/18; G10L 13/08

(52) U.S. Cl. CPC G10L 13/10; G10L 13/06; G10L 13/047; G10L 25/18; G10L 13/086; G10L 2013/105

(57) ABSTRACT

A method for speech synthesis includes obtaining text to be synthesized and an identifier of a speaker, the text being written in a first language; obtaining pronunciation information of each character in the text; generating linguistic features of the text by performing feature extraction on the pronunciation information of each character in the text based on the first language; and obtaining a target speech in a second language other than the first language, by performing speech synthesis based on the linguistic features and the identifier of the speaker.

### CROSS-REFERENCE TO RELATED APPLICATION

This application is based upon and claims priority to Chinese Patent Application No. 202110944989.1, filed on Aug. 17, 2021, the entire contents of which are incorporated herein by reference.

### TECHNICAL FIELD

The disclosure relates to a field of computer technologies, particularly to a field of artificial intelligence technologies such as deep learning and speech technology, and more particularly to a method and an apparatus for speech synthesis, an electronic device and a storage medium.

### BACKGROUND

Speech synthesis technology converts text information into understandable, natural and anthropomorphic speech information, which is widely applied in news broadcasting, car navigation, smart speakers and other fields.

### SUMMARY

According to a first aspect of the disclosure, there is provided a method for speech synthesis. The method includes: obtaining text to be synthesized and an identifier of a speaker, in which the text is written in a first language; obtaining pronunciation information of each character in the text; generating linguistic features of the text by performing feature extraction on the pronunciation information of each character in the text based on the first language; and obtaining a target speech in a second language other than the first language, by performing speech synthesis based on the linguistic features and the identifier of the speaker.

According to a second aspect of the disclosure, there is provided an apparatus for speech synthesis, which includes at least one processor and a memory communicatively connected to the at least one processor. The memory is stored with instructions executable by the at least one processor. When the instructions are executed by the at least one processor, the at least one processor is caused to perform obtaining text to be synthesized and an identifier of a speaker, wherein the text is written in a first language; obtaining pronunciation information of each character in the text; generating linguistic features of the text by performing feature extraction on the pronunciation information of each character in the text based on the first language; and obtaining a target speech in a second language other than the first language, by performing speech synthesis based on the linguistic features and the identifier of the speaker.

According to a third aspect of the disclosure, there is provided a non-transitory computer-readable storage medium, which stores computer instructions. A computer is caused by the computer instructions to perform a method for speech synthesis. The method includes: obtaining text to be synthesized and an identifier of a speaker, wherein the text is written in a first language; obtaining pronunciation information of each character in the text; generating linguistic features of the text by performing feature extraction on the pronunciation information of each character in the text based on the first language; and obtaining a target speech in a second language other than the first language, by performing speech synthesis based on the linguistic features and the identifier of the speaker.

It should be understood that what is described in this section is not intended to identify key or critical features of embodiments of the disclosure, nor is intended to limit the scope of the disclosure. Other features of the disclosure will become readily understood from the following description.

### BRIEF DESCRIPTION OF THE DRAWINGS

The accompanying drawings are used for better understanding the solution and do not constitute a limitation of the disclosure.

FIG. 1 is a schematic flowchart of a method for speech synthesis according to a first embodiment of the disclosure.

FIG. 2 is a schematic flowchart of a method for speech synthesis according to a second embodiment of the disclosure.

FIG. 3 is an example diagram of each tone type of Japanese text according to the second embodiment of the disclosure.

FIG. 4 is an example diagram of pronunciation information of each character in the target text and the prosody example corresponding to each word segmentation according to the second embodiment of the disclosure.

FIG. 5 is an exemplary diagram of corresponding feature items in linguistic features according to the second embodiment of the disclosure.

FIG. 6 is a schematic flowchart of a method for speech synthesis according to a third embodiment of the disclosure.

FIG. 7 is a structural schematic diagram of a speech synthesis model according to a third embodiment of the disclosure.

FIG. 8 is a structural schematic diagram of a training model and a style network according to a third embodiment of the disclosure.

FIG. 9 is a structural schematic diagram of an apparatus for speech synthesis according to a fourth embodiment of the disclosure.

FIG. 10 is a structural schematic diagram of an apparatus for speech synthesis according to a fifth embodiment of the disclosure.

FIG. 11 is a block diagram of an electronic device used to implement the method for speech synthesis of an embodiment of the disclosure.

### DETAILED DESCRIPTION

Exemplary embodiments of the disclosure are described below with reference to the accompanying drawings, which include various details of the embodiments of the disclosure to facilitate understanding and should be considered as exemplary only. Accordingly, those skilled in the art may recognize that various changes and modifications of the embodiments described herein may be made without departing from the scope of the disclosure. Meanwhile, for clarity and conciseness, descriptions for well-known functions and structures are omitted in the following description.

It should be noted that, acquisition, storage and application of personal information for a user involved in the technical solution of the disclosure, comply with the provisions of relevant laws and regulations and do not violate public order and good customs.

With the increasing application scenarios of the speech synthesis technology, the demand for multilingual speech synthesis is increasing. However, since a speaker usually speaks only one language, it is very difficult to obtain a single-person multilingual corpus, and the speech synthesis technology in the related art usually only supports speech synthesis of single-person and single-language. It is of great significance how to realize speech synthesis of single-person and multi-language, for expanding the application scenarios of speech synthesis.

The disclosure proposes a method for realizing speech synthesis of single-person and multi-language. In the method, target text to be synthesized and an identifier of a speaker are first obtained; pronunciation information of at least one character in the target text is then obtained; linguistic features of the target text are generated by performing feature extraction on the pronunciation information of the at least one character in the target text based on a target language to which the target text belongs; and a target speech is obtained by performing speech synthesis based on the linguistic features and the identifier of the speaker. Thus, speech synthesis is performed based on the linguistic features of the target text to be synthesized and the identifier of the speaker, so as to realize speech synthesis of texts in multiple languages for a speaker in one language.

The method and apparatus for speech synthesis, an electronic device, a non-transitory computer-readable storage medium, and a computer program product in the embodiments of the disclosure are described below with reference to the accompanying drawings.

Firstly, the method for speech synthesis according to the disclosure may be described in detail with reference to FIG. 1.

FIG. 1 is a schematic flowchart of a method for speech synthesis according to a first embodiment of the disclosure. It should be noted that, the method for speech synthesis according to the embodiment of the disclosure is executed by an apparatus for speech synthesis. The apparatus for speech synthesis may specifically be an electronic device, or software configured in the electronic device, etc., so as to realize speech synthesis of texts in multiple languages for a speaker in one language. The embodiments of the disclosure are described by taking an example that the apparatus for speech synthesis is configured in an electronic device.

The electronic device may be any stationary or mobile computing device capable of data processing, such as mobile computing devices such as notebook computers, smart phones, and wearable devices, or stationary computing devices such as desktop computers, or servers, or other types of computing devices, etc., which are not limited in this disclosure.

As shown in FIG. 1, the method for speech synthesis may include the following steps 101-104.

At 101, target text to be synthesized and an identifier of a speaker are obtained.

In this embodiment of the disclosure, the text to be synthesized may be any text in any language. The language may be, for example, Chinese, English, Japanese, and the like. The text may be, for example, news text, entertainment text, chat text, and the like. It should be noted that the target text to be synthesized may be text in one language or text in multiple languages, which is not limited in the disclosure.

The identifier of the speaker is used to uniquely identify the speaker to which the target speech synthesized based on the target text belongs. For example, when a speech of speaker A is synthesized based on the target text to be synthesized, the speaker is speaker A; when a speech of speaker B is synthesized based on the target text to be synthesized, the speaker is speaker B.

It should be noted that, the apparatus for speech synthesis in the embodiment of the disclosure may obtain the target text to be synthesized in various public manners that are complied with laws and regulations. For example, the apparatus for speech synthesis may obtain chat text of a chatting user as the target text to be synthesized after being authorized by the chatting user to which the chat text belongs.

At 102: pronunciation information of at least one character in the target text is obtained.

The pronunciation information may include information such as a phoneme, a syllable, a word, a tone, a stress, and a rhotic accent. The phoneme is the smallest phonetic unit divided based on natural properties of the speech. The syllable is a phonetic unit pronounced by combining phonemes. The tone indicates a level of sound. For example, tones in modern standard Chinese pronunciation may include the first tone, the second tone, the third tone, the fourth tone, and the soft tone. For another example, tones in Japanese may include a high tone and a low tone. The stress indicates the stress intensity, which may reflect logical or emotional keys emphasized by the speaker. For example, the stress for English may include three levels of stress intensity from no stress to strong stress. The rhotic accent is a sound change phenomenon for the compound vowel of an individual Chinese character due to a tongue-rolling action, which is characterized by adding suffixation of a nonsyllabic “r” to the end of the compound vowel. Specifically, the pronunciation information of at least one character included in the target text may be obtained by querying based on the target language to which the target text belongs.

Taking as an example, the Chinese text “ [symbol] (Ta men ne dou fei chang xi huan da lie, a pinyin sequence)”, the pronunciation information of each character in the Chinese text may be obtained. The pronunciation information of each character may include “ta1 men5 ne5 dou1 fei1 chang2 xi3 huan1 da3 lie4”, where “t”, “a”, “m”, “en”, “n”, “e”, etc. are phonemes, “ta”, “men”, “ne”, “dou”, etc. are syllables, each two syllables are separated by a space, the numbers represent the Chinese tones, i.e., “1” means the first tone, “2” means the second tone, “3” means the third tone, “4” means the fourth tone, and “5” means the soft tone.

At 103, linguistic features of the target text are generated by performing feature extraction on the pronunciation information of the at least one character in the target text based on a target language to which the target text belongs.

The linguistic features may characterize features of a pitch change, prosody, etc. of the target text.

Since texts in different languages have different features about the pitch change and prosody, in the embodiment of the disclosure, based on the target language to which the target text belongs, feature extraction may be performed on the pronunciation information of at least one character in the target text to generate linguistic features of the target text. The specific method of extracting the features may be described in the following embodiments, and may not be repeated here.

At 104, speech synthesis is performed based on the linguistic features of the target text and the identifier of the speaker to obtain a target speech.

In an exemplary embodiment, a speech synthesis model may be obtained by pre-training, inputs of the speech synthesis model are the linguistic features of the target text and the identifier of the speaker, and the output is a synthesized speech. In this way, the speech synthesis is performed by inputting the linguistic features of the target text and the identifier of the speaker into the trained speech synthesis model, to obtain the target speech.

As for the target text in any language, the feature extraction may be performed on the pronunciation information of at least one character in the target text based on the target language to which the target text belongs, and the linguistic features of the target text are thus generated; speech synthesis is performed based on the linguistic features of the target text and the identifier of the speaker to obtain the target speech. Thus, speech synthesis of text in multiple languages may be realized for a speaker in one language. For example, for a Chinese-speaking speaker A, a target speech of the target text spoken by speaker A in English may be obtained by performing speech synthesis based on the identifier of speaker A and linguistic features of the target text in English. Alternatively, a target speech of the target text spoken by speaker A in Japanese may be obtained by performing speech synthesis based on the identifier of speaker A linguistic features of the target text in Japanese.

The method for speech synthesis according to the embodiment of the disclosure first obtains the target text to be synthesized and the identifier of the speaker, and obtains the pronunciation information of at least one character in the target text; generates linguistic features of the target text by performing feature extraction on the pronunciation information of the at least one character in the target text based on the target language to which the target text belongs; and obtains the target speech by performing speech synthesis based on the linguistic features and the identifier of the speaker. Therefore, by performing speech synthesis based on the linguistic features and the identifier of the speaker, speech synthesis of text in multiple languages may be achieved for a speaker in one language.

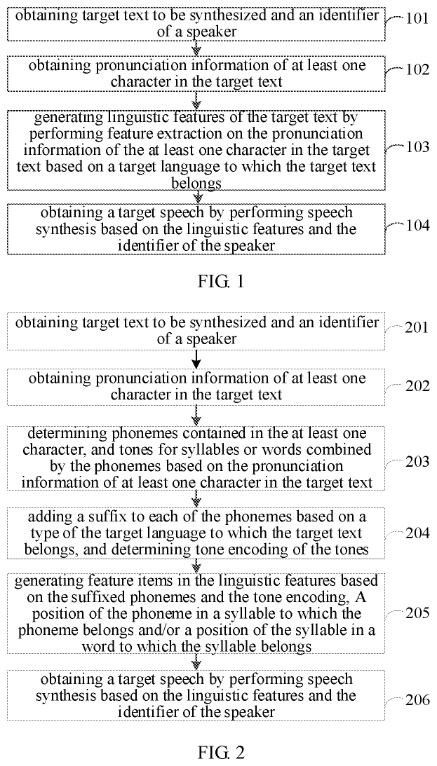

It may be seen from the above description that, in the embodiment of the disclosure, feature extraction may be performed on the pronunciation information of at least one character in the target text based on the target language to which the target text belongs, so as to generate the linguistic features of the target text, thus performing speech synthesis based on the linguistic features of the target text and the identifier of the speaker. The following may further describe the process of generating the linguistic features of the target text in the method for speech synthesis in the disclosure with reference to FIG. 2.

FIG. 2 is a schematic flowchart of a method for speech synthesis according to a second embodiment of the disclosure. As shown in FIG. 2, the method for speech synthesis may include the following steps at 201-206.

At 201, target text to be synthesized and an identifier of a speaker are obtained.

For the specific implementation process and principle at 201, reference may be made to the description of the foregoing embodiment, and details are not repeated here.

At 202, pronunciation information of at least one character in the target text is obtained.

At 203, phonemes contained in the at least one character, and tones for syllables or words combined by the phonemes are determined based on the pronunciation information of at least one character in the target text.

The pronunciation information may include information such as a phoneme, a syllable, a word, a tone, a stress, and a rhotic accent. Thus, phonemes contained in the at least one character, and tones for syllables or words combined by the phonemes may be determined based on the pronunciation information of at least one character in the target text. For a character in the target text, based on one or more combinations of the tone, the stress, and the rhotic accent in the pronunciation information of the characters, the pitch corresponding to each syllable or word combined by the phonemes may be determined, thus improving the accuracy of determining each pitch.

In an exemplary embodiment, for Chinese text, the phonemes contained in the at least one character may be determined based on the pronunciation information of at least one character, and the pitch corresponding to each syllable obtained by combining the phonemes may be determined based on one or two of the tone and the rhotic accent in the pronunciation information of at least one character.

For Japanese text, the phonemes contained in at least one character may be determined based on the pronunciation information of at least one character, and the pitch corresponding to each syllable or word obtained by combining the phonemes may be determined based on the tones in the pronunciation information of at least one character.

For English text, the phonemes contained in at least one character may be determined based on the pronunciation information of at least one character, and the pitch corresponding to each syllable or word obtained by combining the phonemes may be determined based on the stress in the pronunciation information of at least one character.

Taking as an example, the Chinese text “ [symbol] (Ta men ne dou fei chang xi huan da lie, a pinyin sequence)”, the pronunciation information of each character in the Chinese text may be obtained. The pronunciation information of each character may include “ta1 men5 ne5 dou1 fei1 chang2 xi3 huan1 da3 lie4”, where “t”, “a”, “m”, “en”, “n”, “e”, etc. are phonemes, “ta”, “men”, “ne”, “dou”, etc. are syllables, each two syllables are separated by a space, the numbers represent the Chinese tones, i.e., “1” means the first tone, “2” means the second tone, “3” means the third tone, “4” means the fourth tone, and “5” means the soft tone.

It may be determined based on the pronunciation information of each character contained in the above Chinese text that, each character includes the phonemes such as “t”, “a”, “m”, “en”, “n”, “e”, the tone corresponding to the syllable “ta” is the first tone, the tone corresponding to the syllable “men” is the soft tone, the tone corresponding to the syllable “ne” is the soft tone, the tone corresponding to the syllable “dou” is the first tone, the tone corresponding to the syllable “fei” is the first tone, the tone corresponding to the syllable “chang” is the second tone, the tone corresponding to the syllable “xi” is the third tone, the tone corresponding to the syllable “huan” is the first tone, the tone corresponding to the syllable “da” is the third tone, the tone corresponding to the syllable “lie” is the fourth tone. The tone corresponding to each syllable is taken as the pitch corresponding to each syllable.

At 204, a suffix is added to each of the phonemes based on a type of the target language to which the target text belongs, and tone encoding of the tones is determined.

It may be understood that, the phonemes contained in at least one character may be overlapped for texts of different language types. For example, for both Chinese text and English text, there is a phoneme “sh”. In the embodiment of the disclosure, in order to distinguish each phoneme in the texts of different language types and avoid the aliasing of each phoneme in different language types, a suffix may be added to each phoneme.

In an exemplary embodiment, different suffixes may be added for different target language. In an example, for Chinese, no suffix may be added to each phoneme, for phonemes such as “t”, “a”, “m”, “en”, the phonemes before and after adding the suffixes remain unchanged; for Japanese, a suffix “j” may be added to each phoneme, for phonemes such as “yo”, “i”, “yu”, the phonemes after adding the suffix are “yoj”, “ij”, “yuj”; for English, the suffix “1” may be added to each phoneme, for phonemes such as “sh”, “iy”, “hh”, “ae”, the phonemes after adding the suffix are “shl”, “iyl”, “hhl”, “ael”.

In an exemplary embodiment, the tone encoding manner of the pitches may be determined as required.

For example, for Chinese text, the tones “the first tone”, “the second tone”, “the third tone”, “the fourth tone” and “the soft tone” may be encoded as 1, 2, 3, 4, and 5 respectively; the rhotic accent may be encoded as 1, the non-rhotic accent may be encoded as 0. For Japanese text, the high tone may be encoded as 1, and the low tone may be encoded as 0. For English text, the three levels of stress intensity (i.e., no stress, medium stress, and strong stress) may be encoded as 0, 1 and 2, respectively. Therefore, the tone encoding of each tone may be determined based on a type of the target language to which the target text belongs and a tone encoding manner of each tone under each language type.

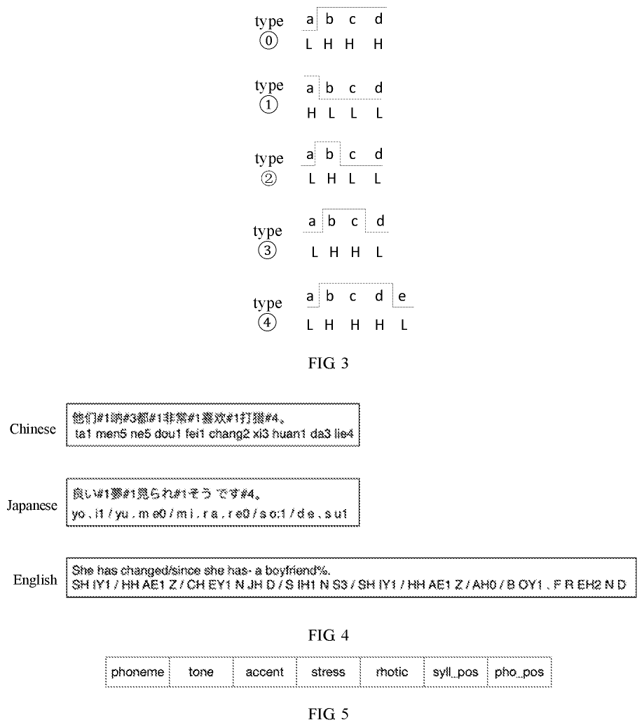

Referring to FIG. 3, the accents of Japanese text include a variety of accents. FIG. 3 only takes the accent type \textcircled{0}, \textcircled{1}, \textcircled{2}, \textcircled{3}, \textcircled{4}, as an example for illustration. The lowercase English letters in FIG. 3 represent syllables, the uppercase English letter “L” represents the low tone, and the capital English letter “H” represents the high tone. As shown in FIG. 3, for the type \textcircled{0}, the first syllable is the low tone, and the following syllables are the high tones; for the type \textcircled{1}, the first syllable is the high tone, and the following syllables are the low tones; for the type \textcircled{2}, the first syllable is the low tone, and the first syllable is low, the second syllable is the high tone, the following syllables are the low tones; for the type \textcircled{3}, the first syllable is the low tone, the second to third syllables are the high tones, and the following syllables are the low tones; for the type \textcircled{4}, the first syllable is the low tone, the second to fourth syllables are the high tones, and the following syllables are the low tones; other tone types are analogous in turn. For the Japanese texts of various tone types shown in FIG. 3, the high tone may be encoded as 1, and the low tone may be encoded as 0.

At 205, feature items in the linguistic features are generated based on the suffixed phonemes and the tone encoding, a position of each phoneme in a syllable to which the phoneme belongs and/or a position of each syllable in a word to which the syllable belongs.

In an exemplary embodiment, for Chinese text, each of the suffixed phonemes and its tone encoding, as well as the position of each phoneme in the syllable to which it belongs, are determined as a feature item in the linguistic feature; for Japanese text and English text, each of the suffixed phonemes and its tone encoding, as well as the position of each phoneme in the syllable to which it belongs and the position of each syllable in the word to which it belongs, are determined as a feature item in the linguistic feature. Each feature item in the linguistic features may represent a pronunciation feature of at least one character in the target text.

The phonemes contained in at least one character and the pitch for syllables or words combined by the phonemes are determined based on the pronunciation information of at least one character in the target text; the suffix is added to each of the phonemes based on the type of the target language to which the target text belongs, and the tone encoding of the pitch is determined; and the feature items in the linguistic features are generated based on the suffixed phonemes and the tone encoding, a position of each phoneme in a syllable to which the phoneme belongs and/or a position of each syllable in a word to which the syllable belongs. In this way, it is achieved that features representing pronunciation features of at least one character in the target text are extracted from the pronunciation information of at least one character in the target text, which lays a foundation for the subsequent generation of linguistic features and speech synthesis based on the linguistic features.

In an exemplary embodiment, the feature item in the linguistic feature may further include a prosody corresponding to each word segmentation in the target text, where the prosody reflects a pause duration of each word segmentation. Accordingly, the step at 202 may further include the following steps of:

segmenting the target text based on the target language to which the target text belongs, and determining a prosody corresponding to each word segmentation; and generating feature items in the linguistic features based on the prosody corresponding to each word segmentation.

In an exemplary embodiment, a pre-trained prosody prediction model may be used to determine the prosody corresponding to each word segmentation. The inputs of the prosody prediction model are the identifier of the speaker and the target text, and the output is the prosody corresponding to each word segmentation of the target text. For a structure of the prosody prediction model and a process of determining the prosody corresponding to each word segmentation with the prosody prediction model, reference may be made to the related art, which will not be repeated here.

In an exemplary embodiment, for Chinese text, the prosody may be divided into four levels, each level representing a pause duration, indicated by #1, #2, #3, #4, respectively. The interior of a prosodic word is 0. #1 indicates a boundary of the prosodic word, basically without the pause. #2 indicates a boundary of a prosodic word, with a perceptible and small pause. #3 indicates a boundary of an intonation phrase, with a perceptible and large pause. #4 indicates the end of the sentence. For Japanese text, the prosody may be divided into 4 levels just like the Chinese. For English text, the prosody may be divided into 4 levels, each representing a pause duration, which are indicated by “-”, “.”, “/”, “%” respectively. “-” means sound Liaison. “.” means the boundary of a word, basically without pause. “/” means the boundary of a prosodic word, with a small pause. “%” means a boundary of an intonation phrase or the end of a sentence, with a large pause.

Referring to FIG. 4, for the target text in Chinese, the target text in Japanese, and the target text in English, the prosody corresponding to each word segmentation in the target text shown in FIG. 4 and the pronunciation information of each character may be obtained respectively. “#1”, “#2”, “#3”, and “#4” in FIG. 4 represent the prosody level corresponding to each word segmentation in Chinese text and Japanese text, respectively. “-”, “.”, “/”, “%” indicate the prosody level corresponding to each word segmentation in the English text. As shown in FIG. 4, for the pronunciation information of each character in the Chinese target text each two syllables are separated by a space, and the numbers from 0 to 5 represent Chinese tones respectively. For the pronunciation information of each character in the Japanese target text, the syllables are separated by “.” and the words are separated by “/”, the numbers 0, 1 represent Japanese tones respectively, “:” represents a long sound. It should be noted that, the long sound in Japanese may lengthen the vowel to 2 syllables and the disclosure mark the long sound and takes the long sound as an independent Japanese phoneme. For the pronunciation information of each character in the English target text, each two phonemes are separated by a space, and each two syllables are separated by “.”, each two words are separated by “/”, and the numbers 0, 1, and 2 represent English stress intensities respectively.

Further, it is possible to determine the phonemes contained in each character, the position of each phoneme in the syllable to which it belongs, and/or the position of each syllable in the word to which it belongs, and the pitches corresponding to the syllables or words obtained by combining the phonemes, based on the pronunciation information of each character in the target text. Then, a suffix is added to each phoneme based on the target language type to which the target text belongs, for example, the suffix “j” is added to the phonemes contained in each character of the Japanese text, and the suffix “l” is added to the phonemes contained in each character of the English text. The tone encoding of each pitch is then determined, i.e., the respective numbers in FIG. 4. In addition, the prosody corresponding to each word segmentation of the target text may be determined, that is, “#1”, “#4”, etc. shown in FIG. 4. Further, the corresponding feature items in the linguistic features may be generated based on each of the suffixed phonemes and its tone encoding, the position of each phoneme in the syllable to which it belongs (pho_pos), the position of each syllable in the word to which it belongs (syll_pos), and the prosody corresponding to each word segmentation. As a result, the corresponding feature items in the generated linguistic features are more abundant, so as to improve the synthesis effect of subsequent speech synthesis based on the linguistic features.

In an exemplary embodiment, the corresponding feature items in the generated linguistic features may be as shown in FIG. 5. For the feature item being the English stress, the feature item may be 0-2 when the target text is English, and the feature item may be 0 when the target text is Chinese or Japanese. For the feature item being the rhotic accent, the feature item may be 0 or 1 (the rhotic accent is 1, the non-rhotic accent is 0) when the target text is Chinese and the feature item may be 0 when the target text is English or Japanese. For the feature item being the position of the syllable in the word to which it belongs (syll_pos), the feature item may be 0 when the target text is Chinese.

In an exemplary embodiment, after the corresponding feature items in the linguistic features are generated, onehot encoding may be performed on each feature item, for example, so as to generate the linguistic features of the target text. Taking each of the suffixed phonemes as an example, each of the suffixed phonemes may be added to a phoneme list independently, and a position index of each phoneme may be obtained based on the phoneme list, so that each of the suffixed phonemes may be converted into the onehot encoding based on the position index. For a specific process of onehot encoding, reference may be made to the related art, which will not be repeated here.

At 206, speech synthesis is performed based on the linguistic features of the target text and the identifier of the speaker to obtain a target speech.

In the method for speech synthesis according to the embodiment of the disclosure, the target text to be synthesized and the identifier of the speaker are obtained; the pronunciation information of at least one character included in the target text is obtained; phonemes contained in the at least one character, and tones for syllables or words combined by the phonemes are determined based on the pronunciation information of at least one character in the target text; the suffix is added to each of the phonemes based on the type of the target language to which the target text belongs, and tone encoding of the tones is determined; feature items in the linguistic features are generated based on the suffixed phonemes and the tone encoding, a position of each phoneme in a syllable to which the phoneme belongs and/or a position of each syllable in a word to which the syllable belongs; speech synthesis is performed based on the linguistic features of the target text and the identifier of the speaker to obtain a target speech. In this way, speech synthesis of text in multiple languages may be achieved for a speaker in one language.

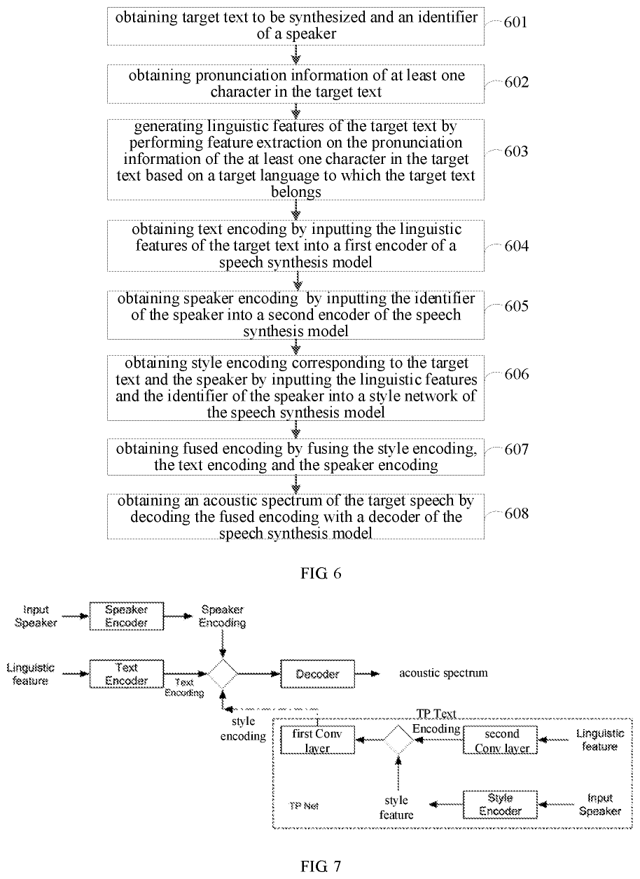

It may be seen from the above analysis that, in the embodiment of the disclosure, a speech synthesis model may be used to perform speech synthesis based on the linguistic features of the target text and the identifier of the speaker, so as to obtain the target speech. In combination with FIG. 6, the process of obtaining the target speech by performing speech synthesis based on the linguistic features of the target text and the identifier of the speaker, may be further described in the method for speech synthesis of the disclosure.

FIG. 6 is a schematic flowchart of a method for speech synthesis according to a third embodiment of the disclosure. As shown in FIG. 6, the method for speech synthesis may include the following steps at 601-608.

At 601, target text to be synthesized and an identifier of a speaker are obtained.

At 602: pronunciation information of at least one character in the target text is obtained.

At 603, linguistic features of the target text are generated by performing feature extraction on the pronunciation information of the at least one character in the target text based on a target language to which the target text belongs.

For the specific implementation and principle of the above steps at 601-603, reference may be made to the description of the above embodiment, and details are not repeated here.

At 604, text encoding is obtained by inputting the linguistic features of the target text into a first encoder of a speech synthesis model.

The text encoding may describe the linguistic features of the target text.

Step 605: speaker encoding of the speaker is obtained by inputting the identifier of the speaker into a second encoder of the speech synthesis model.

In the embodiment of the disclosure, the speaker has a corresponding timbre feature, and different speakers have different timbre features, wherein the speaker encoding may describe the timbre feature of the speaker.

At 606, style encoding corresponding to the target text and the speaker is obtained by inputting the linguistic features and the identifier of the speaker into a style network of the speech synthesis model.

The style network is used to predict prosody information when the speaker narrates the target text, i.e., the cadence and prosody of the speaker when narrating the target text, which is a macro-reflection of a fundamental frequency, a duration, and an ability. The style encoding may describe the prosody information of the speaker when narrating the target text.

At 607, the style encoding, the text encoding and the speaker encoding are fused to obtain fused encoding.

At 608, the fused encoding is decoded with a decoder of the speech synthesis model to obtain an acoustic spectrum of the target speech.

In an exemplary embodiment, the structure of the speech synthesis model is shown in FIG. 7. The speech synthesis model includes a first encoder (i.e., Text Encoder), a second encoder (i.e., Speaker Encoder), a style network (i.e., TP Net), and a decoder (i.e., Decoder). The outputs of the first encoder, the second encoder and the style network are connected to the input of the decoder. The inputs to the speech synthesis model may be linguistic features of the text and a speaker identifier (i.e., Input Speaker), and the output may be an acoustic spectrum of a speech. The acoustic spectrum, for example, may be a Mel spectrum.

The linguistic features of the target text are input into the first encoder to obtain Text Encoding of the target text; the speaker identifier is input into the second encoder to obtain Speaker Encoding of the speaker.

The style network may include a style encoder, a first Cony Layer, and a second Cony Layer. The speaker identifier is input into the style encoder, to obtain a corresponding style feature for the speaker. The linguistic features of the target text are input into the second Cony layer to obtain TP Text Encoding corresponding to the target text. Then, the style feature corresponding to the speaker is fused with the linguistic text encoding corresponding to the target text. The fused encoding is input into the first Cony layer, so that the style encoding corresponding to the target text and the speaker may be obtained. “o” in FIG. 7 indicates that the features are fused.

The fused encoding may be obtained by fusing the style encoding, the text encoding and the speaker encoding, and then a decoder may be used to decode the fused encoding to obtain the acoustic spectrum of the target speech.

In the embodiment of the disclosure, the speech synthesis model is an acoustic model based on fine-grained prosody. By adopting the first encoder, the second encoder, and the style network in the speech synthesis model, the prosody information, the linguistic features of the text, and the timbre feature of the speaker are considered respectively to synthesize a speech, so that during speech synthesis, the prosody information is used as a unique feature instead of being coupled to the speaker and the text, thus reducing a coupling degree between the speaker and the language. In a scenario where speech synthesis of text in multiple languages is performed for a speaker using one language, it is possible to combine only one kind of prosody information, avoiding simultaneous combination of two kinds of prosody information for speech synthesis, thus improving the speech synthesis effect and improving a real degree of the synthesized target speech.

In an exemplary embodiment, the speech synthesis model may be pre-trained before performing speech synthesis based on the linguistic features of the target text and the identifier of the speaker with the speech synthesis model. When training the speech synthesis model, a reference network may be set, and a training model is generated based on the first encoder, the second encoder, the decoder and the reference network of the speech synthesis model. The outputs of the first encoder, the second encoder and the reference network are connected to the input of the decoder, and training data is used to train the training model and the style network. The speech synthesis model is then generated based on the first encoder, the second encoder and the decoder in the trained training model, as well as the trained style network that.

The structure of the reference network may refer to FIG. 8. As shown in FIG. 8, the reference network may include a reference encoder, an attention mechanism module (i.e., Reference Attention). The reference encoder may encode the acoustic spectrum extracted from the speech to obtain acoustic text encoding. The acoustic text encoding may be input into the attention mechanism module, and may be aligned with the linguistic features input into the first encoder via the attention mechanism module, so as to obtain prosody information.

The training data may include linguistic features of text samples, as well as speech samples corresponding to the text samples and speaker identifiers of the speech samples.

It should be noted that, in order to achieve that the generated speech synthesis model may perform speech synthesis of text in multiple languages for a speaker in one language, the training data needs to include text samples and corresponding speech samples in multiple languages. For example, in order to enable the generated speech synthesis model to perform speech synthesis of texts in Chinese, English and Japanese for a Chinese speaker, the training data needs to contain text samples and corresponding speech samples in Chinese, English and Japanese, in which the speaker identifiers for speech samples in various languages may be different. That is, the training data does not require single-person and multi-language training corpora. In addition, the number of speakers for speech samples in each language may be greater than a preset threshold such as 5, thus improving the training effect of the model. In addition, in order to realize single-person and multi-language speech synthesis, the linguistic features of the text samples in each language are uniformly designed and encoded in the embodiments of the disclosure. The text samples in the training data may be manually annotated in the form shown in FIG. 4.

In an exemplary embodiment, training the training model and the style network with the training data may be synchronously training the training model and the style network. The specific training process may be as follows:

inputting a linguistic feature of a text sample into a first encoder in a training model, inputting a speaker identifier of a speech sample into a second encoder of the training model; inputting the speech sample into a reference network of the training model; fusing outputs of the first encoder, the second encoder, and the reference network, decoding the fused output by a decoder in the training model to obtain a predicted acoustic spectrum; adjusting model parameters of the training model based on a difference between the predicted acoustic spectrum and an acoustic spectrum of the speech sample; inputting the linguistic feature of the text sample and the speaker identifier of the speech sample into a style network; adjusting model parameters of the style network based on a difference between the output of the style network and the output of the reference network.

Specifically, for linguistic features of one or more text samples, language samples corresponding to the text samples and speaker identifiers of speech samples, Text Encoding corresponding to the linguistic features of the text samples may be obtained by inputting the linguistic features of the text samples into the first encoder of the training model, speaker encoding corresponding to the speakers may be obtained by inputting the speaker identifiers of the speech samples into the second encoder of the training model, prosody information (i.e., prosody latent) for the speech samples may be obtained by inputting the speech samples into the reference network of the training model. Then, it is fused that the prosody information output by the reference network, the text encoding output by the first encoder, and the speaker encoding output by the second encoder, to obtain a fused encoding. The fused encoding is decoded by a decoder to obtain a predicted acoustic spectrum. Then, in combination with the difference between the predicted acoustic spectrum and the acoustic spectrum of the speech sample, model parameters of the training model are adjusted. The style encoding (output by the style network) may be obtained by inputting the linguistic features of the text samples and the speaker identifiers of the speech samples into the style network, while the linguistic features of the text samples are input into the first encoder of the training model and the speaker identifiers of the speech samples are input into the second encoder of the training model. Then, model parameters of the style network are adjusted based on the difference between the style encoding output by the style network and the prosody information output by the reference network.

Therefore, the model parameters of both the training model and the style network are continuously adjusted based on the linguistic features of the multiple text samples, the speech samples corresponding to the text samples, and the speaker identifier of the speech samples which are included in the training samples, and iterative training is performed for the training model and the style network, until the accuracy of output results of the training model and the style network meets a preset threshold, and the training process ends. Thus, the training model and the style network trained are obtained. After the training model and the style network are trained, a speech synthesis model may be generated based on the first encoder, the second encoder, the decoder in the trained training model and the trained style network.

By synchronously training the training model (composed of the first encoder, the second encoder, the decoder, the reference network) and the style network, after the training is completed, the speech synthesis model is generated based on the first encoder, the second encoder, the decoder and the style network. That is, during model training, training is performed in consideration of the reference network having an input including the speech samples, and after the training, there is no need for reference network, which may get rid of the dependence on the speech input when the trained speech synthesis model is used for speech synthesis. For any text, the speech synthesis model may be used for speech synthesis, and the synchronous training of the training model and the style network may improve the training efficiency of the model.

To sum up, the method for speech synthesis according to the embodiment of the disclosure first obtains the target text to be synthesized and the identifier of the speaker, and obtains the pronunciation information of at least one character in the target text; generates linguistic features of the target text by performing feature extraction on the pronunciation information of the at least one character in the target text based on the target language to which the target text belongs; obtains text encoding by inputting the linguistic features of the target text into the first encoder of the speech synthesis model; obtains speaker encoding of the speaker by inputting the identifier of the speaker into the second encoder of the speech synthesis model; obtains style encoding corresponding to the target text and the speaker by inputting the linguistic features and the identifier of the speaker into the style network of the speech synthesis model; obtains fused encoding by fusing the style encoding, the text encoding and the speaker encoding; obtains the acoustic spectrum of the target speech by decoding the fused encoding with the decoder of the speech synthesis model. In this way, speech synthesis of text in multiple languages may be achieved for a speaker in one language. The speech synthesis effect is improved, and the real degree of the synthesized target speech is improved.

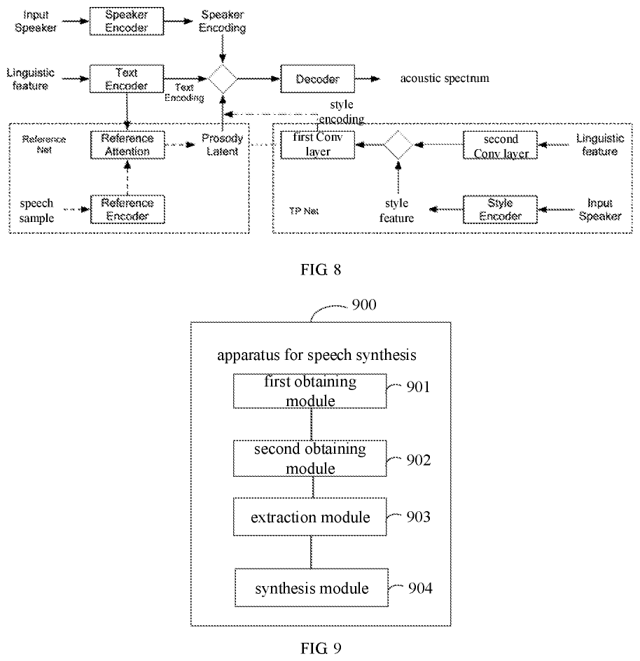

The apparatus for speech synthesis according to the disclosure may be described below with reference to FIG. 9.

FIG. 9 is a structural schematic diagram of an apparatus for speech synthesis according to a fourth embodiment of the disclosure.

As shown in FIG. 9, the apparatus 900 for speech synthesis according to the disclosure includes: a first obtaining module 901, a second obtaining module 902, an extraction module 903, and a synthesis module 904.

The first obtaining module 901 is configured to obtain target text to be synthesized and an identifier of a speaker.

The second obtaining module 902 is configured to obtain pronunciation information of at least one character in the target text.

The extraction module 903 is configured to generate linguistic features of the target text by performing feature extraction on the pronunciation information of the at least one character in the target text based on a target language to which the target text belongs.

The synthesis module 904 is configured to obtain a target speech by performing speech synthesis based on the linguistic features and the identifier of the speaker.

It should be noted that, the apparatus for speech synthesis according to this embodiment may execute the method for speech synthesis of the foregoing embodiment. The apparatus for speech synthesis may be an electronic device, or may be software configured in the electronic device, so as to realize speech synthesis of text in multiple languages for a speaker in one language.

The electronic device may be any stationary or mobile computing device capable of data processing, such as mobile computing devices such as notebook computers, smart phones, and wearable devices, or stationary computing devices such as desktop computers, or servers, or other types of computing devices, etc., are not limited in this disclosure.

It should be noted that the foregoing description of the embodiments of the method for speech synthesis is also applicable to the apparatus for speech synthesis according to the disclosure, and details are not repeated here.

The apparatus for speech synthesis according to the embodiment of the disclosure first obtains the target text to be synthesized and the identifier of the speaker, and obtains the pronunciation information of at least one character in the target text; generates linguistic features of the target text by performing feature extraction on the pronunciation information of the at least one character in the target text based on the target language to which the target text belongs; and obtains the target speech by performing speech synthesis based on the linguistic features and the identifier of the speaker. Therefore, by performing speech synthesis based on the linguistic features and the identifier of the speaker, speech synthesis of text in multiple languages may be achieved for a speaker in one language.

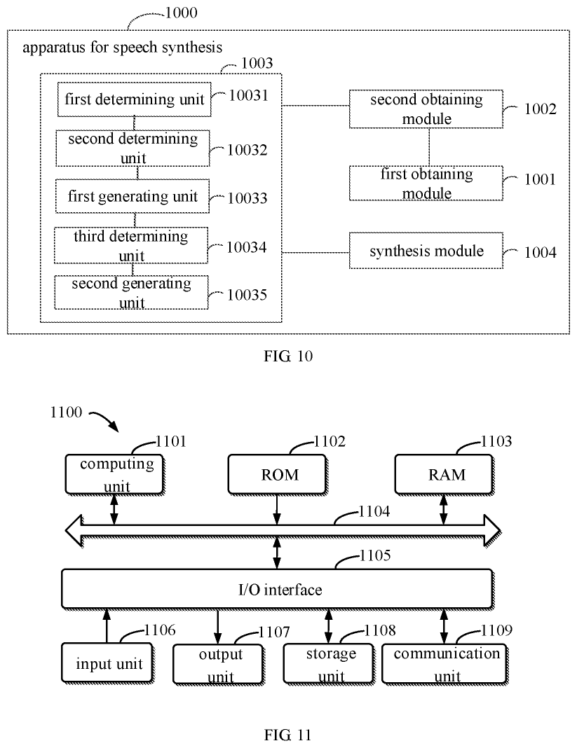

The apparatus for speech synthesis according to the disclosure may be described below with reference to FIG. 10.

FIG. 10 is a structural schematic diagram of an apparatus for speech synthesis according to a fifth embodiment of the disclosure.

As shown in FIG. 10, the apparatus 1000 for speech synthesis may specifically include: a first obtaining module 1001, a second obtaining module 1002, an extraction module 1003 and a synthesis module 1004. The first obtaining module 1001, the second obtaining module 1002, the extraction module 1003 and the synthesis module 1004 in FIG. 10 have the same functions and structures as the first obtaining module 901, the second obtaining module 902, the extraction module 903 and the synthesis module 904 in FIG. 9.

In an exemplary embodiment, the extraction module 1003 includes a first determining unit 10031, a second determining unit 10032, and a first generating unit 10033.

The first determining unit 10031 is configured to determine phonemes contained in the at least one character, and tones for syllables or words combined by the phonemes based on the pronunciation information of at least one character in the target text.

The second determining unit 10032 is configured to add a suffix to each of the phonemes based on a type of the target language to which the target text belongs, and determine tone encoding of the tones.

The first generating unit 10033 is configured to generate feature items in the linguistic features based on the suffixed phonemes and the tone encoding, a position of each phoneme in a syllable to which the phoneme belongs and/or a position of each syllable in a word to which the syllable belongs.

In an exemplary embodiment, the first determining unit 10031 includes: a determining subunit, configured to determine the tones for syllables or words combined by the phonemes based on one or more combination of the tone, the stress, and the rhotic accent in the pronunciation information of the at least one character in the target text.

In an exemplary embodiment, the extraction module 1003 further includes: a third determining unit 10034, and a second generating unit 10035. The third determining unit 10034 is configured to segment the target text based on the target language to which the target text belongs, and determining a prosody corresponding to each word segmentation. The second generating unit 10035 is configured to generate the feature items in the linguistic features based on the prosody corresponding to each word segmentation.

In an exemplary embodiment, the synthesis module 1004 includes: a first encoding unit configured to obtain text encoding by inputting the linguistic features of the target text into a first encoder of a speech synthesis model; a second encoding unit configured to obtain speaker encoding of the speaker by inputting the identifier of the speaker into a second encoder of the speech synthesis model; a third encoding unit configured to obtain style encoding corresponding to the target text and the speaker by inputting the linguistic features and the identifier of the speaker into a style network of the speech synthesis model; a fusion unit configured to obtain fused encoding by fusing the style encoding, the text encoding and the speaker encoding; and a decoding unit configured to obtain an acoustic spectrum of the target speech by decoding the fused encoding with a decoder of the speech synthesis model.

In an exemplary embodiment, the apparatus 1000 for speech synthesis may further include: a first generation module, configured to generate a training model based on the first encoder, the second encoder, the decoder and a reference network of the speech synthesis model, where an input of the decoder is connected to outputs of the first encoder, the second encoder and the reference network; a training module, configured to train the training model and a style network with training data; a second generation module, configured to generate the speech synthesis model based on the first encoder, the second encoder and the decoder in the trained training model, and the trained style network.

In an exemplary embodiment, the training data includes linguistic features of text samples, speech samples corresponding to the text samples and speaker identifiers of the speech samples. The training module includes: a first processing unit, configured to input the linguistic features of the text samples into the first encoder in the training model, and input the speaker identifiers of the speech samples into the second encoder in the training model; a second processing unit, configured to input the speech sample into the reference network of the training model; a third processing unit, configured to fuse an output of the reference network, an output of the first encoder and an output of the second encoder, and obtain a predicted acoustic spectrum by decoding with the decoder in the training model; a first adjustment unit, configured to adjust model parameters of the training model based on a difference between the predicted acoustic spectrum and an acoustic spectrum of the speech sample; a fourth processing unit, configured to input the linguistic features of the text samples and the speaker identifiers of the speech samples into the style network; and a second adjustment unit, configured to adjust model parameters of the style network based on a difference between an output of the style network and an output of the reference network.

It should be noted that the foregoing description on the embodiments of the method for speech synthesis is also applicable to the apparatus for speech synthesis according to the disclosure, and details are not repeated here.

The apparatus for speech synthesis according to the embodiments of the disclosure first obtains the target text to be synthesized and the identifier of the speaker, and obtains the pronunciation information of at least one character in the target text; generates linguistic features of the target text by performing feature extraction on the pronunciation information of the at least one character in the target text based on the target language to which the target text belongs; and obtains the target speech by performing speech synthesis based on the linguistic features and the identifier of the speaker. Therefore, by performing speech synthesis based on the linguistic features and the identifier of the speaker, speech synthesis of text in multiple languages may be achieved for a speaker in one language.

According to the embodiments of the disclosure, the disclosure also provides an electronic device, a readable storage medium and a computer program product.

FIG. 11 is a block diagram of an example electronic device 1100 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 11, the device 1100 includes a computing unit 1101 performing various appropriate actions and processes based on computer programs stored in a read-only memory (ROM) 1102 or computer programs loaded from the storage unit 1108 to a random access memory (RAM) 1103. In the RAM 1103, various programs and data required for the operation of the device 1100 are stored. The computing unit 1101, the ROM 1102, and the RAM 1103 are connected to each other through a bus 1104. An input/output (I/O) interface 1105 is also connected to the bus 1104.

Components in the device 1100 are connected to the I/O interface 1105, including: an inputting unit 1106, such as a keyboard, a mouse; an outputting unit 1107, such as various types of displays, speakers; a storage unit 1108, such as a disk, an optical disk; and a communication unit 1109, such as network cards, modems, and wireless communication transceivers. The communication unit 1109 allows the device 1100 to exchange information/data with other devices through a computer network such as the Internet and/or various telecommunication networks.

The computing unit 1101 may be various general-purpose and/or dedicated processing components with processing and computing capabilities. Some examples of computing unit 1101 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 1101 executes the various methods and processes described above, such as the method for speech synthesis. For example, in some embodiments, the method for speech synthesis may be implemented as a computer software program, which is tangibly in a machine-readable medium, such as the storage unit 1108. In some embodiments, part or all of the computer program may be loaded and/or installed on the device 1100 via the ROM 1102 and/or the communication unit 1109. When the computer program is loaded on the RAM 1103 and executed by the computing unit 1101, one or more steps of the method described above may be executed. Alternatively, in other embodiments, the computing unit 1101 may be configured to perform the method for speech synthesis in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet, and a blockchain network.

The computer system may include a client and a server. The client and server are generally remote from each other and interacting through a communication network. The client-server relation is generated by computer programs running on the respective computers and having a client-server relation with each other. The server may be a cloud server, a distributed system server, or a server combined with a block-chain. The cloud server is also known as a cloud computing server or cloud host, which is a host product in a cloud computing service system for solving the defects existing in conventional physical hosts and virtual private server (VPS) services that management difficulties are large and business expansion is weak.

The disclosure relates to a field of computer technologies, particularly to a field of artificial intelligence technologies such as deep learning and speech technology.

It should be noted that, the artificial intelligence is a study of making computers to simulate certain thinking processes and intelligent behaviors (such as learning, reasoning, thinking, planning, etc.) of people, involving in both hardware-level technologies and software-level technologies. The artificial intelligence hardware technologies generally include technologies such as sensors, dedicated artificial intelligence chips, cloud computing, distributed storage, and big data processing. The artificial intelligence software technologies mainly include computer vision, speech recognition technology, natural language processing technology, and major directions such as machine learning/deep learning, big data processing technology, knowledge-graph technology.

According to the technical solutions in the embodiments of the disclosure, speech synthesis is performed based on the linguistic features of the target text to be synthesized and the identifier of the speaker, so as to realize speech synthesis of texts in multiple languages for a speaker in one language.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. A method for speech synthesis, comprising:
obtaining text to be synthesized and an identifier of a speaker, wherein the text is written in a first language;
obtaining pronunciation information of each character in the text;
generating linguistic features of the text by performing feature extraction on the pronunciation information of each character in the text based on the first language; and
obtaining a target speech in a second language other than the first language, by performing speech synthesis based on the linguistic features and the identifier of the speaker.

2. The method of claim 1, wherein generating linguistic features of the text by performing feature extraction on the pronunciation information of each character in the text, comprises:
determining phonemes contained in each character, and tones for syllables or words based on the pronunciation information of each character in the text, wherein each of the syllables has a plurality of phonemes, and each of the word has a plurality of syllables;
adding a suffix to each of the phonemes based on a type of the first language, and determining tone encoding of the tones; and
generating feature items in the linguistic features based on the suffixed phonemes and the tone encoding, a position of each phoneme in a syllable to which the phoneme belongs and/or a position of each syllable in a word to which the syllable belongs.

3. The method of claim 2, wherein determining phonemes contained in each character, and tones for syllables or words combined by the phonemes comprises:
determining the tones for syllables or words based on one or more combination of a tone, a stress, and a rhotic accent included in the pronunciation information.

4. The method of claim 2, wherein generating linguistic features of the text by performing feature extraction on the pronunciation information of each character in the text, comprises:
segmenting the text based on the first language to obtain a plurality of word segmentations, and determining a prosody level corresponding to each of the word segmentations; and
generating the feature items in the linguistic features based on the prosody level corresponding to each of the word segmentations.

5. The method of claim 1, wherein obtaining the target speech by performing speech synthesis comprises:
obtaining text encoding by inputting the linguistic features of the text into a first encoder of a speech synthesis model;
obtaining speaker encoding by inputting the identifier of the speaker into a second encoder of the speech synthesis model;
obtaining style encoding corresponding to the text and the speaker by inputting the linguistic features and the identifier of the speaker into a style network of the speech synthesis model;
obtaining fused encoding by fusing the style encoding, the text encoding and the speaker encoding; and
obtaining an acoustic spectrum of the target speech by decoding the fused encoding with a decoder of the speech synthesis model.

6. The method of claim 5, wherein before obtaining text encoding by inputting the linguistic features of the text into the first encoder of the speech synthesis model, the method further comprises:
generating a first model based on the first encoder, the second encoder, the decoder and a reference network of the speech synthesis model, wherein an input of the decoder is connected to outputs of the first encoder, the second encoder and the reference network;
training the first model and a style network with training data; and
generating the speech synthesis model based on the first encoder, the second encoder and the decoder in the trained first model, and the trained style network.

7. The method of claim 6, wherein the training data comprises linguistic features of text samples, speech samples corresponding to the text samples and speaker identifiers of the speech samples;
training the first model and the style network with training data comprises:
inputting the linguistic features of the text samples into the first encoder of the first model, and inputting the speaker identifiers of the speech samples into the second encoder of the first model;
inputting the speech samples into the reference network of the first model;
fusing an output of the reference network, an output of the first encoder and an output of the second encoder to obtain a fused output, and obtaining a predicted acoustic spectrum by decoding the fused output with the decoder in the first model;
adjusting model parameters of the first model based on a difference between the predicted acoustic spectrum and an acoustic spectrum of the speech sample;
inputting the linguistic features of the text samples and the speaker identifiers of the speech samples into the style network; and
adjusting model parameters of the style network based on a difference between an output of the style network and an output of the reference network.

8. An apparatus for speech synthesis, comprising:
at least one processor; and
a memory communicatively connected to the at least one processor and configured to store instructions executable by the at least one processor, when the instructions are executed by the at least one processor, the at least one processor is caused to implement:
obtaining text to be synthesized and an identifier of a speaker, wherein the text is written in a first language;
obtaining pronunciation information of each character in the text;
generating linguistic features of the text by performing feature extraction on the pronunciation information of each character in the text based on the first language; and
obtaining a target speech in a second language other than the first language, by performing speech synthesis based on the linguistic features and the identifier of the speaker.

9. The apparatus of claim 8, wherein the at least one processor is further caused to implement:
determining phonemes contained in the each character, and tones for syllables or words based on the pronunciation information of each character in the text, wherein each of the syllables has a plurality of phonemes, and each of the word has a plurality of syllables;
adding a suffix to each of the phonemes based on a type of the first language, and determining tone encoding of the tones; and
generating feature items in the linguistic features based on the suffixed phonemes and the tone encoding, a position of each phoneme in a syllable to which the phoneme belongs and/or a position of each syllable in a word to which the syllable belongs.

10. The apparatus of claim 9, wherein the at least one processor is further caused to implement:
determining the tones for syllables or words based on one or more combination of a tone, a stress, and a rhotic accent included in the pronunciation information.

11. The apparatus of claim 9, wherein the at least one processor is further caused to implement:
segmenting the text based on the first language to obtain a plurality of word segmentations, and determining a prosody level corresponding to each of the word segmentations; and
generating the feature items in the linguistic features based on the prosody level corresponding to each of the word segmentations.

12. The apparatus of claim 8, wherein at least one processor is further caused to implement:
obtaining text encoding by inputting the linguistic features of the text into a first encoder of a speech synthesis model;
obtaining speaker encoding by inputting the identifier of the speaker into a second encoder of the speech synthesis model;
obtaining style encoding corresponding to the text and the speaker by inputting the linguistic features and the identifier of the speaker into a style network of the speech synthesis model;
obtaining fused encoding by fusing the style encoding, the text encoding and the speaker encoding; and
obtaining an acoustic spectrum of the target speech by decoding the fused encoding with a decoder of the speech synthesis model.

13. The apparatus of claim 12, wherein the at least one processor is further caused to implement:
generating a first model based on the first encoder, the second encoder, the decoder and a reference network of the speech synthesis model, wherein an input of the decoder is connected to outputs of the first encoder, the second encoder and the reference network;
training the first model and a style network with training data; and
generating the speech synthesis model based on the first encoder, the second encoder and the decoder in the trained first model, and the trained style network.

14. The apparatus of claim 13, wherein the training data comprises linguistic features of text samples, speech samples corresponding to the text samples and speaker identifiers of the speech samples;
the at least one processor is further caused to implement:
inputting the linguistic features of the text samples into the first encoder of the first model, and input the speaker identifiers of the speech samples into the second encoder of the first model;
inputting the speech samples into the reference network of the first model;
fusing an output of the reference network, an output of the first encoder and an output of the second encoder to obtain a fused output, and obtaining a predicted acoustic spectrum by decoding the fused output with the decoder in the first model;
adjusting model parameters of the first model based on a difference between the predicted acoustic spectrum and an acoustic spectrum of the speech sample;
inputting the linguistic features of the text samples and the speaker identifiers of the speech samples into the style network; and
adjusting model parameters of the style network based on a difference between an output of the style network and an output of the reference network.

15. A non-transitory computer readable storage medium having computer instructions stored thereon, wherein the computer instructions are configured to implement a method for speech synthesis, the method comprising:
obtaining text to be synthesized and an identifier of a speaker, wherein the text is written in a first language;
obtaining pronunciation information of each character in the text;
generating linguistic features of the text by performing feature extraction on the pronunciation information of each character in the text based on the first language; and
obtaining a target speech in a second language other than the first language, by performing speech synthesis based on the linguistic features and the identifier of the speaker.

16. The storage medium of claim 15, wherein generating linguistic features of the text by performing feature extraction on the pronunciation information of each character in the text, comprises:
determining phonemes contained in each character, and tones for syllables or words based on the pronunciation information of each character in the text, wherein each of the syllables has a plurality of phonemes, and each of the word has a plurality of syllables;
adding a suffix to each of the phonemes based on a type of the first language, and determining tone encoding of the tones; and
generating feature items in the linguistic features based on the suffixed phonemes and the tone encoding, a position of each phoneme in a syllable to which the phoneme belongs and/or a position of each syllable in a word to which the syllable belongs.

17. The storage medium of claim 16, wherein determining phonemes contained in each character, and tones for syllables or words combined by the phonemes comprises:
determining the tones for syllables or words based on one or more combination of a tone, a stress, and a rhotic accent included in the pronunciation information.

18. The storage medium of claim 16, wherein generating linguistic features of the text by performing feature extraction on the pronunciation information of each character in the text, comprises:
segmenting the text based on the first language to obtain a plurality of word segmentations, and determining a prosody level corresponding to each of the word segmentations; and
generating the feature items in the linguistic features based on the prosody level corresponding to each of the word segmentations.

19. The storage medium of claim 15, wherein obtaining the target speech by performing speech synthesis comprises:
obtaining text encoding by inputting the linguistic features of the text into a first encoder of a speech synthesis model;
obtaining speaker encoding by inputting the identifier of the speaker into a second encoder of the speech synthesis model;
obtaining style encoding corresponding to the text and the speaker by inputting the linguistic features and the identifier of the speaker into a style network of the speech synthesis model;
obtaining fused encoding by fusing the style encoding, the text encoding and the speaker encoding; and
obtaining an acoustic spectrum of the target speech by decoding the fused encoding with a decoder of the speech synthesis model.

20. The storage medium of claim 19, wherein before obtaining text encoding by inputting the linguistic features of the text into the first encoder of the speech synthesis model, the method further comprises:
generating a first model based on the first encoder, the second encoder, the decoder and a reference network of the speech synthesis model, wherein an input of the decoder is connected to outputs of the first encoder, the second encoder and the reference network;
training the first model and a style network with training data; and
generating the speech synthesis model based on the first encoder, the second encoder and the decoder in the trained first model, and the trained style network.
